(19) United States
(12) Patent Application Publication
(10) Pub. No.: US 2011/0113942 A1
(43) Pub. Date: May 19, 2011

(54) DIVIDER INSERT FEED SYSTEM

(76) Inventors: Doug Petrovich, New Carlisle, IN (US); Randy Bird, Douglas, MI (US); Les Page, Stevensville, MI (US); Matt Williamson, Saint Joseph, MI (US)

(21) Appl. No.: 12/905,038

(22) Filed: Oct. 14, 2010

Related U.S. Application Data
(63) Continuation of application No. 11/938,774, filed on Nov. 12, 2007, now abandoned.

(51) Int. Cl. B26D 7/01; B26D 5/38; B65B 61/20

(52) U.S. Cl. 83/370; 83/418; 53/410

(57) ABSTRACT

A divider insert feed system having a first air knife 120 and a second air knife 125 that are capable of displacing the divider insert 230 to a cutting position 500. If the first air knife 120 does not properly position the divider insert, then the second air knife 125 is activated to displace the divider insert. If after activating the second air knife 125 it does not properly displace the divider insert, then the first air knife 120 and second air knife 125 toggle back and forth to unjam the divider insert, and properly locate it in a cutting position.

### RELATED APPLICATIONS

The present application is a continuation of U.S. patent application Ser. No. 11/938,774, filed on 21 Nov. 2007, which is currently not abandoned.

### BACKGROUND OF THE INVENTION

This invention relates to an apparatus, system and method of displacing paper from a paper roll to a desired length piece of paper called a divider insert, then positioning the divider insert into position.

This invention is capable of cutting the paper to form the divider insert, and then displacing the cut paper or divider insert by means of up to two air knives to a location under a blade and above an adjustable opening. The blade then descends, and in the case of an ultrasonic blade, pushing the paper through the adjustable or cam controlled opening, and folding the cut paper, also called a divider insert. In the case of a mechanical blade, there is no need to have a cam controlled opening because the mechanical blade is thinner than the ultrasonic blade. The descending blade then positions the divider insert between adjacent portions of a food product.

U.S. Pat. No. 4,299,148 issued in 1981 to Meier shows the method of cutting a food item in which a sheet of wax paper is folded about the cutting edge of a guillotine blade before the blade is forced into the food item. The sheet of wax paper then remains as a separator.

U.S. Pat. No. 5,138,823 issued in 1992 to Hartman et al. shows a complex machine for introducing foil-like material between slices of a food product that has, apparently, already been cut by a cutting machine. U.S. Pat. No. 4,565,053 issued Jan. 21, 1986 to Browne and Hertzberg discloses an apparatus for cutting round pastries, such as cake, and then after cutting inserting a divider between each two adjacent portions.

U.S. Pat. No. 5,862,728 issued in 1999 to Giamello shows an apparatus for cutting food products in which a cutting blade energized with ultrasonic vibrations is driven through different layers of a food product at a controlled and variable speed.

U.S. Pat. No. 6,662,529, and No. 6,860,091, issued in 2003 and 2005 respectively to Grano disclose an ultrasonic method for inserting dividers in pastries. This discloses a cutting blade that is ultrasonically energized during a first cutting movement to cut the food. The blade is withdrawn, and then after a divider sheet is under the blade, the blade drives the sheet between the food. And a camming mechanism assists in folding the sheet

U.S. Pat. No. 5,879,000, issued in 1999 to Kakuta discloses an air jet to move a document.

As can be seen, there is a need for am apparatus, system and method that can quickly cut paper from a roll, using less mechanical parts then in the existing art. There is also a need to be able to quickly and easily adjust the desired length of the paper to be inserted. There is also a need for a divider insert feed system that does not cause the divider inserts to curl up, curl down, or jam. In some instances, the divider insert may get stuck before being placed in position to separate food. Thus, there is also a need to create an apparatus that can un-jam a stuck or jammed divider insert quickly and safely without human intervention.

### SUMMARY OF THE INVENTION

One aspect of the present invention is a divider insert feed system, comprising: a drive roller (50) capable of displacing paper; at least one of an upper shear blade (100) or a lower shear blade (90) that is positioned downstream of said drive roller (50), said upper shear blade (100) and said lower shear blade (90) capable of cutting a length of paper to form a divider insert (230); a first air knife (120) that is capable of displacing the divider insert (230) to a cutting position (500); a divider present sensor (320) capable of detecting if the divider insert (230) is in a cutting position (500), a second air knife (125) that is capable of displacing the divider insert (230) to a cutting position (500); a slicing blade (20) disposed upwardly from said divider insert (230), said slicing blade (20) capable of descending and pushing said divider insert (230) downwardly to position said divider insert (230) into position into a workpiece.

Another aspect is a method of displacing divider inserts between adjacent pieces of a food item, comprising the steps of: providing (600) a divider insert roll; displacing (610) a portion of the divider insert roll adjacent a shear blade; cutting (620) a portion of said divider insert roll to form a divider insert (230); displacing (630) said divider insert (230) through an air knife (120) to be positioned downwardly from a blade (20); sensing (635) if the divider insert (230) is downwardly from said blade (20), if so, then the step of displacing (640) said divider insert downwardly; and if not, then the step of activating (650) a second air knife (125), and then sensing (635) if the divider insert (230) is downwardly from said blade (20), if so, then the step of displacing (640) said divider insert downwardly; and if not, then the next step is toggling (660) said first air knife (120) and said second air knife (125).

These and other features, aspects and advantages of the present invention will become better understood with reference to the following drawings, description and claims.

### BRIEF DESCRIPTION OF THE DRAWINGS

FIG. 1 illustrates one pictorial of an embodiment of the present invention;

FIG. 2 illustrates a pictorial of an embodiment of the present invention;

FIG. 3 illustrates a sectional view of the air knife of detail B of FIG. 1;

FIG. 4 illustrates another embodiment of the present invention having a second air knife and divider present sensor and algorithm or program; and

FIG. 5 illustrates a divider insert being bent and displaced downwardly; and

FIG. 6 illustrates a method of displacing a divider insert between respective portions of a food product.

### DETAILED DESCRIPTION OF THE INVENTION

### Reference Numerals

10 DIVIDER INSERT FEED SYSTEM
20 BLADE
30 DIVIDER INSERT ROLL
40 DIVIDER INSERT PATH
50 DIVE ROLLER
60 PINCH ROLLER
70 PINCH ROLLER RELEASE
80 SHEAR ACTUATOR
90 LOWER SHEAR BLADE
100 UPPER SHEAR BLADE
110 VACUUM CHAMBER
120 FIRST AIR KNIFE
125 SECOND AIR KNIFE
130 DIVIDER INSERT FOLD CREASE
140 DIVIDER PRESENT SENSOR
150 DIVIDER ADJUSTABLE STOP
160 DIVIDER FOLD STOP
170 DIVIDER INSERT FEED ROLLER
180 DIVIDER INSERT STOP AND FEEDER
190 CAM ROLLER
200 FOLD CREASE CAM
210 INSERT SCALE
220 GUIDE ROLLER
230 DIVIDER INSERT
240 AIR GAP
250 FIRST AIR FLOW
255 SECOND AIR FLOW
260 AIR CHAMBER INLET
265 CHAMBER SPACE
267 FIRST WALL
270 RADIUS
275 SECOND WALL
280 SUCTION POINT
295 AIR EXIT PORTION
300 TOP WALL
310 BOTTOM WALL
320 DIVIDER PRESENT SENSOR
500 CUTTING POSITION
600 PROVIDING A DIVIDER INSERT ROLL
610 DISPLACING A PORTION OF THE DIVIDER INSERT ROLL
620 CUTTING
630 DISPLACING SAID DIVIDER INSERT VIA A FIRST AIR KNIFE
635 SENSING THE LOCATION OF THE DIVIDER INSERT
640 DISPLACING SAID DIVIDER INSERT DOWNWARDLY
650 ACTIVATING A SECOND AIR KNIFE
660 TOGGLING BETWEEN THE FIRST AIR KNIFE AND SECOND AIR KNIFE TO UNJAM THE STUCK DIVIDER INSERT

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be used to cut paper from a roll to form divider inserts, and position the divider inserts between adjacent food items.

The present invention differs from the prior art by, among other things, the use of an air knife to displace the cut divider inserts at a high rate of speed. The use of a first air knife allows the procedure to be accomplished with less moving parts than a comparable machine with mechanical parts in lieu of the first or second air knife.

The present invention also has a second air knife disposed downstream from the first air knife to assist in displacing the divider insert to its desired location.

The present invention also has a sensor that detects if the paper is under a blade after the first air knife attempts at displacing the divider insert under the blade. The sensor may detect if the first air knife does not displace the divider insert under the blade, to turn on the second air knife to assist in displacing the divider insert to its desired location.

The present invention also has a program, that, if after the second air knife's first failed attempt at displacing the divider insert, the program causes the first air knife and second air knife to alternate turning on and off, or toggle on and off, to further assist in unjamming any stuck divider insert.

Also, the present invention may use a roll of paper, or a set of paper rolls, from which paper is displaced before being cut, then repositioned by means of an air knife to a location under an ultrasonic or mechanical slicing blade, which descends downwardly to reposition the insert.

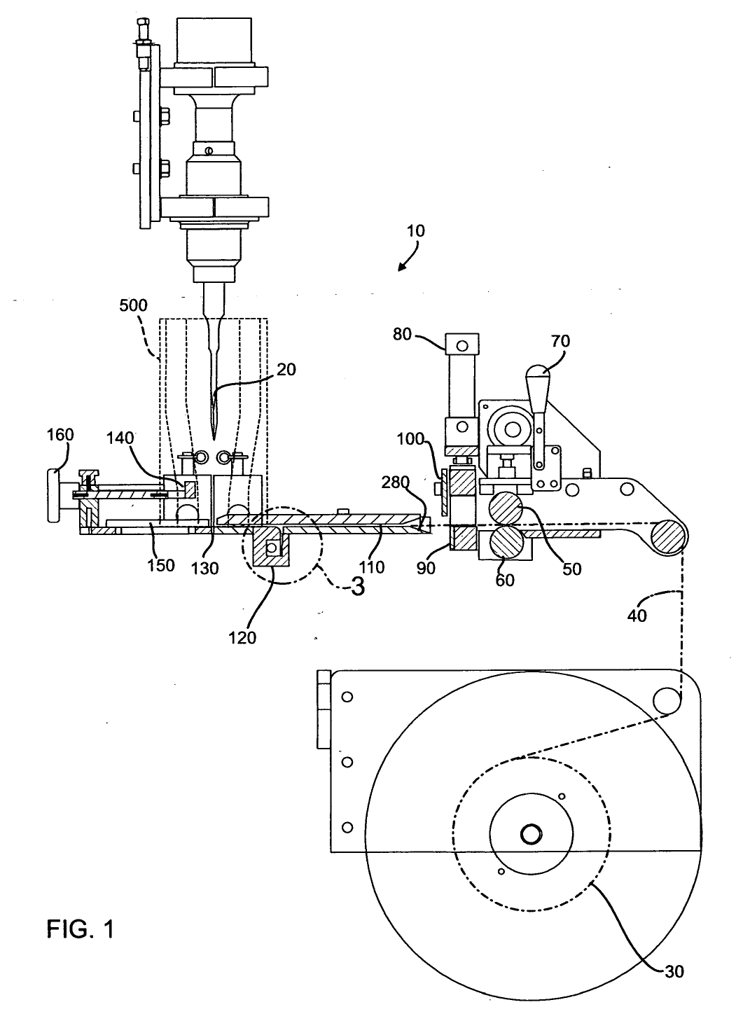

FIG. 1 is a sectional view of one embodiment of the present invention 10. A divider insert roll 30 may be capable of receiving a roll of paper thereon. A guide roller 220 may be disposed to define a divider insert path 40 for the paper. A drive roller 50 may operatively engage a pinch roller 60 to displace paper between the drive roller 50 and the pinch roller 60 toward a cutting member, such as an upper shear blade 100 and a lower shear blade 90. When paper is between the upper shear blade 100 and the lower shear blade 90, the blades 100, 90 may be actuated to cut the paper off of the roll at a desired length. In many applications, divider inserts may range from 2 inches to 7 inches.

A first air knife 120 may displace the cut paper, also referred to herein as a divider insert 230 through a vacuum chamber to a divider adjustable stop 150. In one exemplary embodiment of the present invention, the vacuum chamber 110 may be defined by a top wall 300 and bottom wall 310 of the air knife. In one exemplary embodiment, the distance from the top wall 300 to the bottom wall 310 may be about 0.002 inches. In another embodiment, the distance from the top wall 300 to the bottom wall 310 may be greater than 0.002 inches, or less than 0.002 inches. In one embodiment the distance between the top wall 300 and the bottom wall 310 may be about 0.001 inches. In another embodiment, the distance between the top wall 300 and the bottom wall 310 may be about 0.004 inches.

The divider adjustable stop 150 may enable the cut paper 230 to stop mid-way above a divider insert fold crease forming edge 130, and below an ultrasonic or mechanical slicing blade 20. The divider present sensor 140 may sense the position of the cut paper 230, to activate the ultrasonic or mechanical slicing blade 20, also referred to herein as a slicing blade 20. When activated, the slicing blade 20 descends, and moves the cut paper 230, also referred to herein as a divider insert 230, downwardly, to be positioned, generally between two adjacent pieces of food, such as cake slices, which are disposed below the divider insert fold crease forming edge 130. The general operation of the slicing blade 20 may be described in U.S. Pat. Nos. 6,662,529, and 6,860,091, both assigned to Foodtools, Inc.

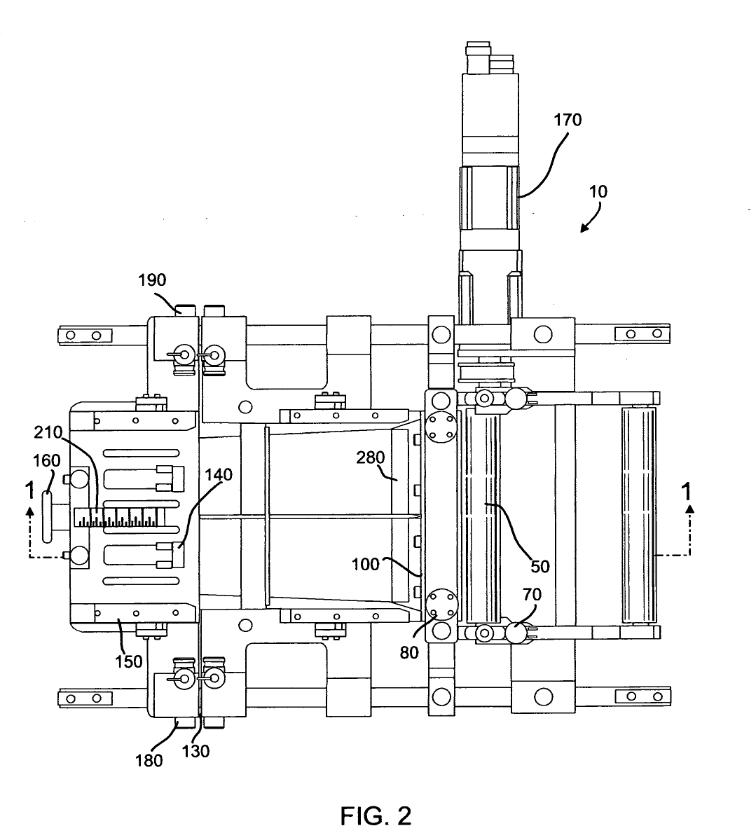

FIG. 2 illustrates a top view of one embodiment of the present invention 10. A divider insert feed roller servo motor is shown at 170, also referred to herein as a motor 170. The motor 170 may be operatively connected to drive the divider insert roll 30.

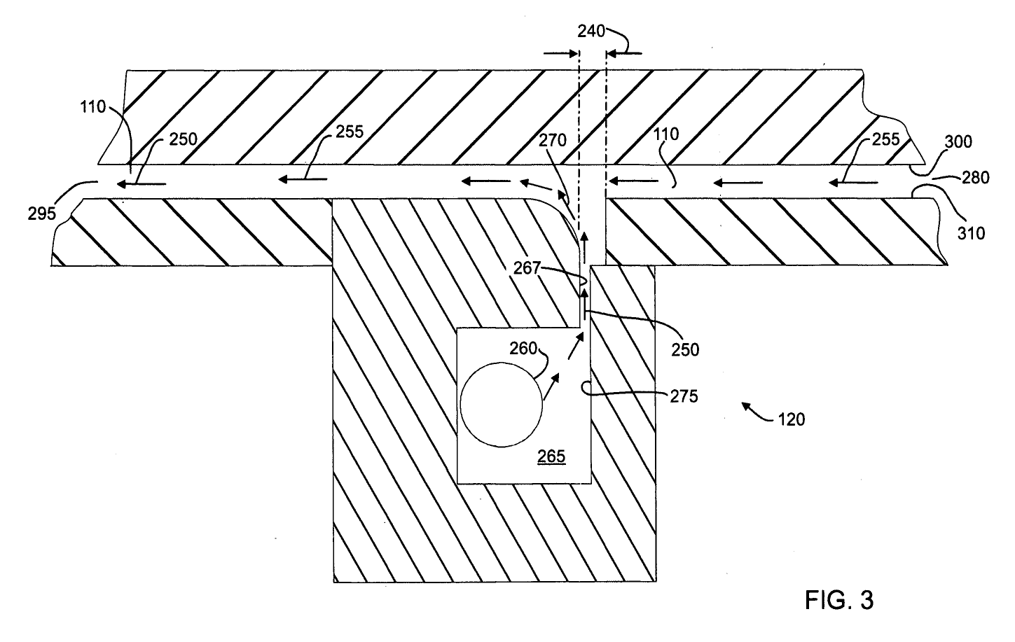

FIG. 3 illustrates a first air knife 120 in larger view of detail B of FIG. 1. The first air knife 120 may have a chamber space 265 therein to receive air. In one exemplary embodiment, the chamber space 265 may have an air chamber inlet 260, which may displace air into the first air knife 120. The air may be displaced in such a way as to follow a first air flow 250 from the air chamber inlet 260, upwardly through an air gap 240, and then through a conduit also referred to herein as a vacuum chamber 110. The first air knife 120 may have an air gap 240 that is defined by a first wall 267 and a second wall 275. In one exemplary embodiment of the present invention, the air gap 240 may be 0.002 inches. In a further embodiment, the air gap may be greater than or less than 0.002 inches. A radius 270 may be disposed tangent to the first wall 267 and a surface of the conduit 110 so the air may flow from the chamber space 265, adjacent to the radius 270 and through the conduit or vacuum chamber 110. In one exemplary embodiment the radius 270 is about 0.250 inches. The first air flow 250 may cause a displacement of air, herein referred to as a second air flow 255 from a suction point 280 through the vacuum chamber or conduit 110 in the same direction as the first air flow 250. The first air flow 250 and second air flow 255 may cause the divider insert 230 to move from the suction point 280, leftwardly (in this FIG. 3) to its proper location under the slicing blade 20 to be displaced downwardly into the food item. However, in some instances, the above operation may not place the divider insert 230 at its desired location, in which case a divider present sensor 320 detects that there is no divider insert 230 at the desired location, such as under the slicing blade 20. The divider present sensor 320 then activates a second air knife 125 to assist in displacing any jammed or stuck divider insert 230.

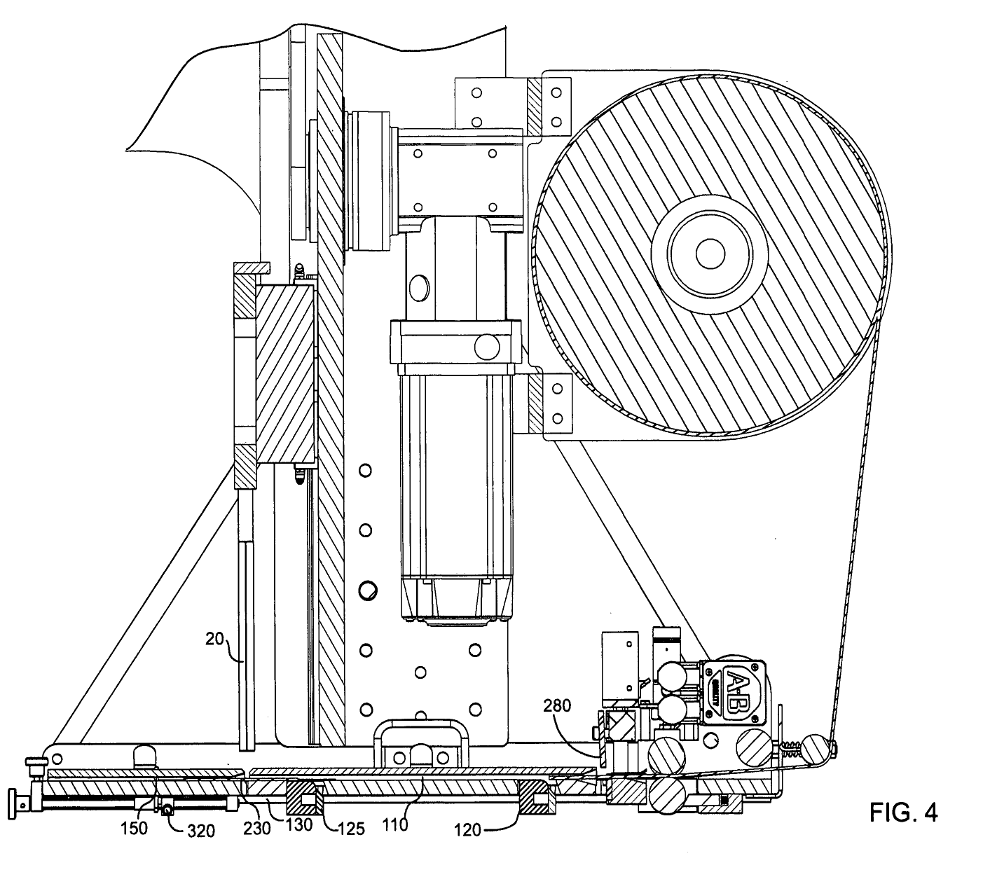

FIG. 4 illustrates one embodiment of the present invention having a second air knife 125. In one embodiment the second air knife 125 is located downstream from the first air knife 120 at a distance of about 7 inches. In one embodiment, the first air knife 120 is located about 1 inch from the suction point 280 or entryway. In one embodiment the divider insert fold crease 130 may be located downstream from the second air knife 125. In another embodiment the divider insert fold crease 130 may be located between the first air knife 120 and the second air knife 125. FIG. 4 also illustrates the divider present sensor 320, which identifies if the divider insert 230 is located in the desired location.

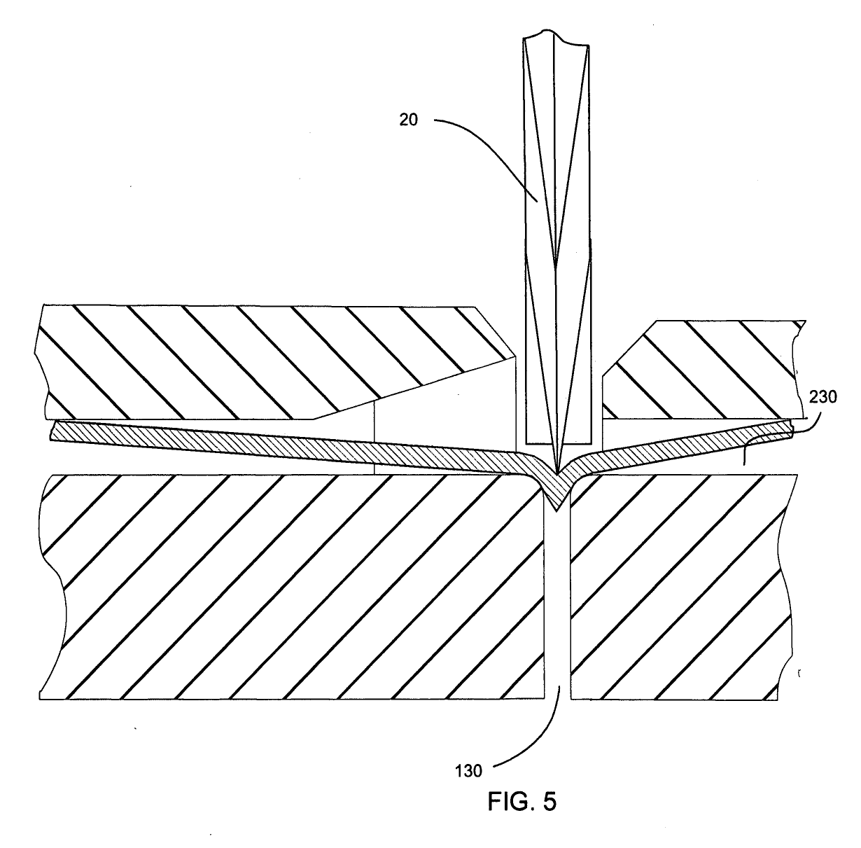

FIG. 5 discloses an embodiment of the present invention illustrating the divider insert 230 and how it may be contacted with the blade 20 to be displaced downwardly.

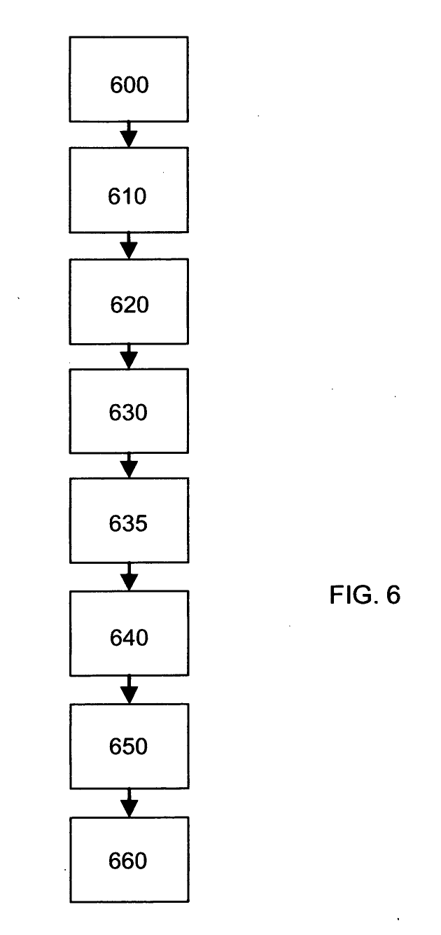

FIG. 6 illustrates an embodiment of a method of displacing divider inserts 230 between adjacent pieces of a food item, comprising the steps of providing 600 a divider insert roll; displacing 610 a portion of the divider insert roll adjacent a shear blade; cutting 620 a portion of said divider insert roll to form a divider insert 230; displacing 630 said divider insert 230 through an air knife 120 to be positioned downwardly from a slicing blade. The divider present sensor 320 then detects if the divider insert 230 is in its desired position, which may be underneath the blade 20. It the divider insert 230 is not in its desired position, than then the next step may be activating 650 a second air knife 125; and if the divider insert 230 is still not in its desired position, then the next step may be toggling 660 between the first air knife 120 and second air knife 125 to displace said divider insert 230 under a blade 20. Once the divider insert 230 is in the cutting position 500, then the step of displacing 640 said divider insert 230 downwardly.

In one embodiment, if the divider insert 230 is not in its desired position, as it may be detected via the divider present sensor 320, within 0.2 seconds after the first air knife 120 is activated, and then the second air knife 125 is activated. And if the divider insert 230 is still not in its desired location, then the first air knife 120 and second air knife 125 are on at alternating points in time, referred to herein as toggling, to unjam the jammed or stuck divider insert 230.

In operation, in one embodiment of the present invention, the divider insert feed system 10 is fed from divider insert roll 30 and is guided over a roller 220 into a set of pinch rollers 60 one of which may be driven. The pinch rollers 60 may be driven by a servo motor (not illustrated) to determine the exact length of the individual divider insert 230. Once the length has been fed through the pinch rollers 60 into the vacuum chamber 110, also referred to herein as the pneumatic conveying chamber 110 and has stopped, a mechanical shear, which may comprise an upper shear blade 100 and a lower shear blade 90, is activated and cuts the paper to the proper sized divider insert 230.

A first linear venturi 120 or first air knife 120 creates a vacuum on the entrance 280, also referred to herein as a suction point 280, of the pneumatic conveying chamber 110. When the paper is cut to form the divider insert 230, the vacuum 255, also referred to herein as the second air flow 255 moves the divider insert 230 horizontally or downstream (leftwardly in this FIG. 3) to the first venturi 120 and then air pressure or displaced air moves the divider insert 230 the rest of the way to position the divider insert 230, preferably exactly half way under the slicing/insertion blade 20 up against the adjustable divider fold stop 150 to center the divider insert 230. Once the divider insert 230 is in place, the divider insert present sensors 140 are activated and the air pressure is turned off.

At this point, the slicing blade 20 begins to travel downwardly. At the point where the slicing blade 20 contacts the divider insert 230, the divider insert 230 begins to fold around the blade 20 and between the divider insert fold crease forming edges 130 as it moves downward.

As the slicing blade 20 descends, in the case of an ultrasonic blade 20, the divider insert fold crease cam 200 contacts the divider insert fold crease cam rollers 190 and the divider insert fold crease forming edges 130 open to allow the blade 20 to pass through without contacting any other components. If the blade 20 in use is a mechanical blade 20, then there is no need for the camming mechanism or fold crease cam 200 because the mechanical blade 20 is thinner at certain locations then the ultrasonic blade 20.

The slicing blade 20 may continue downwardly with the divider insert 230 wrapped around it and the slicing blade 20 cuts the product and inserts the divider insert 230, in a food item, all in the same motion. When the slicing blade 20 reaches the bottom it reverses and moves up, as the divider insert 230 may remain in the position it was placed when the slicing blade 20 reached the bottom. The slicing blade 20 then may move upwardly to the starting position where the reciprocating vertical (slicing blade 20 reciprocating from starting position to the bottom position) cycle is repeated as many times as needed.

In one exemplary embodiment of the present invention 10, the pneumatic conveying chamber 110 or vacuum chamber 110 may be 14.5 inches in length, as measured from the suction point 280 to the air exit portion 295; and may be 12.5 inches in width (as measured perpendicular with respect to the length). In one exemplary embodiment of the present invention 10, the vacuum chamber 110 may be capable of displacing a divider insert 230 that may have a length between 2 inches and 12 inches, and a width between 2 inches and 6 inches. In another embodiment, the vacuum chamber 110 may be 14.5 inches in width, and may be 12.5 inches in length. In one exemplary embodiment of the present invention, the vacuum chamber 110 may have an opening

In one exemplary embodiment of the present invention, the mechanical blade 20 may be made of stainless steel. In another embodiment, the mechanical blade 20 may be made of 301 full hardness stainless steel.

The force, flow, and compressed air consumption may be controlled by a pressure regulator with filter. In one exemplary embodiment, a compressed air supply may be on one side of the first air knife 120.

The first air knife 120 or second air knife 125 may have a 0.002 inch opening to allow a precise air flow to move the divider insert 230 horizontally from the suction point 280 across the venture and first air knife 120 and second air knife 125 to the adjustable divider fold stop 150.

The air supply may be from 10 pound-force per square inch gauge (PSIG) to 100 PSIG and the air consumption may be from 1 to 4 square cubic feet per minute (SCFM) based on a 12 inch wide air knife 120. The velocity of the second air flow 255 may be from 2000 feet per minute to 13,000 feet per minute at 6 inches from the adjustable divider fold stop 150 based on a 12 inch air knife 120. In one exemplary embodiment of the present invention, the downward velocity of the slicing blade 20 may be from 2000 feet per minute to 13,000 feet per minute.

In one exemplary embodiment of the present invention, a compressor or other air supply may force air into the chamber space 265 or into the air chamber inlet 260, to then be displaced as the first air flow 250, which in turn causes the second air flow 255.

It should be understood, of course, that the foregoing relates to exemplary embodiments of the invention and that modifications may be made without departing from the spirit and scope of the invention as set forth in the following claims.

We claim:

1. A divider insert feed system, comprising:
a drive roller (50) capable of displacing paper,
at least one of an upper shear blade (100) or a lower shear blade (90) that is positioned downstream of said drive roller (50), said upper shear blade (100) and said lower shear blade (90) capable of cutting a length of paper to form a divider insert (230);
a first air knife (120) that is capable of displacing the divider insert (230) to a cutting position (500);
a divider present sensor (320) capable of detecting if the divider insert (230) is in a cutting position (500),
a second air knife (125) that is capable of displacing the divider insert (230) to a cutting position (500)
a slicing blade (20) disposed upwardly from said divider insert (230), said slicing blade (20) capable of descending and pushing said divider insert (230) downwardly to position said divider insert (230) into position into a workpiece.

2. The apparatus of claim 1, wherein said blade (20) is an ultrasonic blade (20).

3. The apparatus of claim 1, wherein said blade (20) is a mechanical blade (20).

4. The apparatus of claim 1, wherein said first air knife (120) is disposed upstream from said blade (20).

5. The apparatus of claim 1, wherein at least one of said first air knife (120) or said second air knife (125) has an air gap (240) of about 0.002 inches.

6. The apparatus of claim 1, wherein said cutting position (500) is disposed downstream of both said second air knife (125) and said first air knife (120).

7. The apparatus of claim 1, further comprising at least one divider insert path (40), whereby multiple divider insert rolls (30) may be used simultaneously, and multiple slicing blades (20) may be respectively used simultaneously.

8. The apparatus of claim 1, wherein at least one of said first air knife (120) or said second air knife (125) has a vacuum chamber (110) defined by a top wall (300) and a bottom wall (310).

9. The apparatus of claim 1, wherein a first wall (267) and a bottom wall (310) are integral with a radius (270).

10. The apparatus of claim 9, wherein said radius is about 0.25 inches.

11. The apparatus of claim 1, wherein an air chamber inlet (260) is disposed downwardly from an air gap (240), whereby air can flow from said air chamber inlet (260) to said air gap (240).

12. The apparatus of claim 1, further comprising a first air flow (250) starting in the air gap (240) and displacing downstream through a vacuum chamber (110).

13. The apparatus of claim 12, further comprising a second air flow (255) extending from a suction point (280) downstream to the first air flow (250).

14. The apparatus of claim 8, wherein the top wall (300) is separated from said bottom wall (310) by a distance of about 0.002 inches.

15. The apparatus of claim 1, wherein said cutting position (500) is disposed downstream of said first air knife (120), and upstream from said second air knife (125).

16. The apparatus of claim 1, wherein said divider present sensor (320) is disposed to detect if a divider insert is in the cutting position (500), and if not said divider present sensor (320) activates said second air knife (125).

17. The apparatus of claim 1, wherein said divider present sensor (320) is disposed to detect if a divider insert is in the cutting position (500) after the first air knife (120) is turned on, and if not said divider present sensor (320) activates said second air knife (125), and if said divider insert (230) is still not in a cutting position (500), the first air knife (120) and second air knife (125) toggle on and off until said divider insert (230) is in the cutting position (500).

18. A method of displacing divider inserts between adjacent pieces of a food item, comprising the steps of:
providing (600) a divider insert roll;
displacing (610) a portion of the divider insert roll adjacent a shear blade;
cutting (620) a portion of said divider insert roll to form a divider insert (230);
displacing (630) said divider insert (230) through an air knife (120) to be positioned downwardly from a blade (20);
sensing (635) if the divider insert (230) is downwardly from said blade (20), if so, then the step of displacing (640) said divider insert downwardly;
and if not, then the step of activating (650) a second air knife (125), and then sensing (635) if the divider insert (230) is downwardly from said blade (20), if so, then the step of displacing (640) said divider insert downwardly; and
if not, then the next step is toggling (660) said first air knife (120) and said second air knife (125).
